(19) United States
(12) Patent Application Publication
(10) Pub. No.: US 2006/0151279 A1
(43) Pub. Date: Jul. 13, 2006

(54) Parking lock mechanism for a motor vehicle comprising one automatic transmission, particularly a continuously variable belt drive transmission

(76) Inventor: Sebastian Ortner, Oberreute (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/318,749

(22) Filed: Dec. 27, 2005

(30) Foreign Application Priority Data
Jan. 13, 2005 (DE) 10 2005 001 549.2

(51) Int. Cl. F16H 63/38

(52) U.S. Cl. 192/219.5

(57) ABSTRACT

A parking lock mechanism is proposed for a motor vehicle which has one automatic transmission, particularly one continuously variable belt transmission, having one locking pawl tiltably situated on one end and which, when the parking lock is activated, engages with one tooth in a parking lock gear non-rotatably situated upon the output shaft or secondary shaft and one locking member which is movably situated against the force of a spring upon a connecting rod connected with a selector mechanism and, by its movements, the locking pawl is rotatable to locking position between the locking pawl and a guide plate or a supporting lock, a stop mechanism (10) is provided on the end of the connecting rod (6) remote from the selector mechanism or on the free end of the connecting rod (6) to prevent the retraction of the locking member (2) from the guide plate (3) when the parking lock is activated.

This application claims priority from German Application Serial No. 10 2005 001 549.2 filed Jan. 13, 2005.

### FIELD OF THE INVENTION

This invention concerns a parking lock mechanism for a motor vehicle comprising one automatic transmission, particularly a belt drive transmission.

### BACKGROUND OF THE INVENTION

Parking lock mechanisms for automatic transmission are known from the prior art. These mechanisms usually have one prestressed spring which activates a parking lock. A mechanism linkage or a hydraulically or pneumatically actuated cylinder is customarily employed to deactivate the parking lock. An actuating rod of the linkage or a piston rod of the cylinder here work together respectively with a parking pawl and a parking gear wheel.

DE 35 37 091 C1 has disclosed a parking lock having one parking gear wheel non-rotatably situated upon the output shaft of the transmission, one tiltable parking pawl which, between a stationary position and an active position, is movably engaged with the parking gear wheel, one lever connected with the manual selector lever and which, via a bent end, is connected with one actuating rod, one sliding sleeve movable against the force of an engagement spring opposite the actuating rod and provided with a conical shoulder for moving the parking pawl from the stationary position to the active position and one guide for the sliding sleeve in the housing, the actuating rod being shaped on its end facing the sliding sleeve by upsetting to a thickened piston part which is guided into a cylinder part of the sliding sleeve.

From the Applicant's DE 199 33 618 A1, a parking lock device for an automatic transmission is further known comprising one parking lock gear having one toothing, one locking pawl being lockable in the toothing while the locking pawl, guided to a locking device having one locking cone, is rotatable to locking position. The locking cone is located upon a connecting element movably against a spring device to a stop plate or a selector shaft.

In addition, the Applicant's DE 41 27 991 C2 describes a parking lock for an automatic transmission in motor vehicles having one parking lock mechanism switchable by a manual selector lever and having a movable actuating rod which interacts with a parking pawl and one parking gear wheel. At the same time, the actuating rod is the piston rod of an easily acting cylinder which is located in the interior of the transmission housing and, in pressureless state, holds the actuating rod advanced and thus the parking lock closed opening it during pressurization.

The locking cone or the locking member of these parking lock mechanisms is usually fastened in a locked state between the locking pawl and a guide plate or a supporting bolt so as to prevent the locking pawl from being forced out of the tooth space of the parking lock gear.

In the parking lock mechanism, known from the prior art, it can occur that the parking pawl disadvantageously does not engage when abruptly sliding which results in the rolling of the vehicle. The reasons for this is that the locking cone movably situated against the force of a spring upon the actuating or connecting rod, upon activation of the parking lock bounces against the guide plate due to the force of the prestressed spring and then retracts therefrom together with the locking pawl (during this process the locking cone remains in operative connection with the locking pawl which it pushes out of the way) thus being impossible to preserve in axial direction a minimal overlapping of the sides of the locking cone between guide plate and locking pawl. The force acting upon the cone also has a component that extends perpendicularly to the longitudinal axis of the connecting rod producing the retraction of the locking cone.

For the case that prior to activation of the parking lock, that is, in prestress of the spring, the locking pawl is at the beginning of a tooth of the parking lock gear, the pawl has to leave the whole tooth to be able to fall into the space whereby the vehicle is accelerated relatively slowly resulting in that the relative speed between pawl and parking lock gear is so high that the pawl bounces back and retracts due to the small overlapping relative to the locking cone.

The reason for a “no locking” is that the cone remains on the pawl and pushes it back. The cone remains on the pawl since it retracts together with it from the guide plate (independently of speed).

The problem on which this invention is based is to outline a parking lock mechanism for a motor vehicle comprising one automatic transmission, particularly a continuously variable belt transmission, which overcomes the above mentioned disadvantages of the prior art. A reliable engagement of the parking lock independently of the slope inclination and of the relative position of the locking pawl with regard to the parking lock gear is particularly to be ensured.

### SUMMARY OF THE INVENTION

A parking lock mechanism for a motor vehicle is proposed which comprises one automatic transmission, particularly one continuously variable belt transmission, having tiltably situated on one end one locking pawl which, when the parking lock is activated, engages with one tooth in a parking lock gear non-rotatably situated upon the output shaft or the secondary shaft and one locking member which is movably situated against the force of a spring upon one connecting rod connected with the selector mechanism and by its movement. Due to the force of the spring, the locking pawl is rotatable to a locking position between the locking pawl and a guide plate or a supporting bolt in which, on the end of the connecting rod remote from the selector mechanism or on the free end of the connecting rod means, are provided to prevent the retraction of the locking member from the guide plate when the parking lock is activated.

Within the scope of a specially advantageous embodiment of the invention, one stop is provided for the connecting rod on the free end of the connecting rod.

The inventive idea ensures a reliable activation of the parking lock independently or the rod inclination in a simple manner.

### BRIEF DESCRIPTION OF THE DRAWINGS

The invention will now be described, by way of example, with reference to the accompanying drawings in which:

FIG. 1 is a schematized graph of the movements relative to each other of a locking pawl, a locking cone and a guide plate, the same as the locking pawl and the parking lock gear, when the parking lock is activated according to the prior art; and

FIG. 2 is a schematized graph of the movements relative to each other of the locking pawl, the locking cone and the guide plate, the same as the locking pawl and the parking lock gear, when a parking lock is activated according to the instant invention.

### DETAILED DESCRIPTION OF THE INVENTION

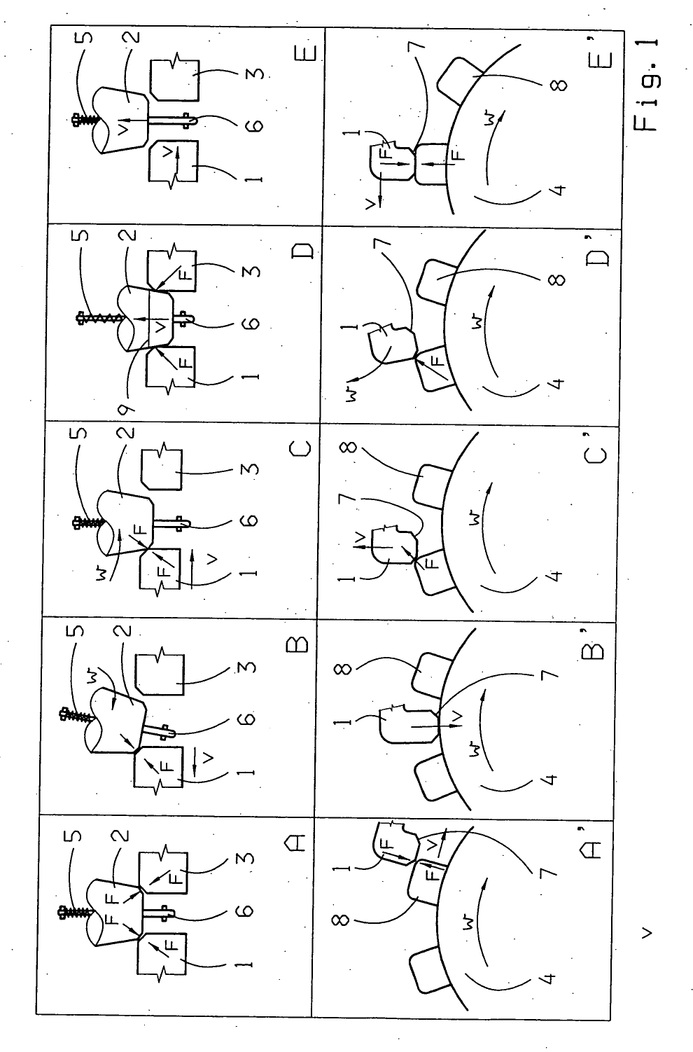

FIG. 1 comprises ten sectional Figures which illustrate five separate stages of the movements relative to each other of a locking pawl 1, a locking cone 2 and a guide plate 3, the same as the locking pawl 1 and a parking lock gear 4, when the parking lock is activated. In the upper row are illustrated the relative movements and force ratios of the locking pawl, the locking cone and the guide plate, and in the lower row are illustrated the relative movements and force ratios of the locking pawl and the parking lock gear. Superimposed sectional Figures represent the situation at the same point in time. The forces are shown with the vectors F; the angular speed w of the parking lock gear 4 and the speed v of the locking pawl 1 relative to the parking lock gear 4.

In the sectional Figures A and A′ of FIG. 1 is shown the situation prior to activation of the parking lock, a spring 5 placed upon a connecting rod 6 being still prestressed. In this condition, the locking cone 2 is on the locking pawl 1 and on the guide plate 3. A tooth 7 of the locking pawl 1 is here prior to activation of the parking lock, that is, in prestressed state of the spring 5, at the beginning of a tooth 8 of the parking lock gear 4. In the situation shown here, where the locking pawl 1 falls in the space of the parking lock gear 4, the locking cone 2 slips off on the slope of the locking pawl 1 and of the guide plate 3. Since the guide plate 3 is tightly screwed on the housing, the locking cone 2 presses with the locking pawl 1 on the end of the slope of the guide plate 3, as shown in the sectional Figs. B, C, D and, retracting therefrom so that a minimal overlapping of the sides of the locking cone 2 cannot be preserved in axial direction between the guide plate 3 and the locking pawl 1. The sectional Figs. B′, C′ and D′ show the corresponding movements relative to each other of the locking pawl 1 and the parking lock gear 4. The minimal overlapping is designated in the sectional Fig. D with a reference numeral 9. The minimal overlapping 9 must be maintained, inasmuch as the locking cone 2, after activation of the parking lock, somewhat shifts back.

When the minimal overlapping 9 is not maintained, the result is that the locking cone 2 springs out between the locking pawl 1 and the guide plate 3 so that the parking lock cannot be activated, as shown in sectional Figs. E and E′.

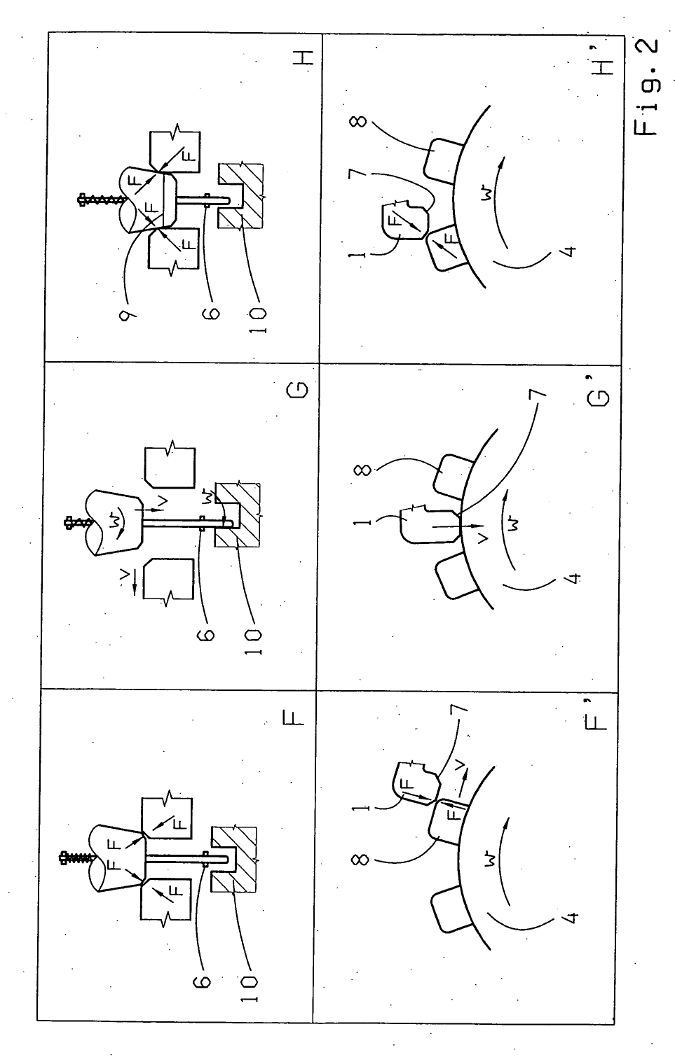

According to the invention, a stop 10 is provided on the free end of the connecting rod 6, which prevents a retraction of the locking cone 2 from the guide plate 3. The effect of the stop 10 is illustrated within the scope of the sectional Figs. F, G, H or F′, G′, H′ contained in FIG. 2. As shown in the Figures, the stop 10 is designed as a hole into which projects the free end of the connecting rod 6 in a manner such as to prevent the movement of the connecting rod laterally or in radial direction.

The situation according to Figs. F and F′ corresponds to the situation shown in Figs. A and A′. The same as in FIG. 1, the relative movements and force ratios of the locking pawl 1, the locking cone 2 and the guide plate 3 are illustrated in the upper row, and in the lower row the relative movements and the force ratios of the locking pawl 1 and the parking lock gear 4. Superimposed sectional Figures show the situation at the same moment. With the vectors F are shown the forces, the angular speed w of the parking lock gear 4 and the speed v of the locking pawl 1 relative to the parking lock gear 4.

As shown in the sectional Fig. G, a lateral movement of the connecting rod 6 is prevented by the stop 10 so that the locking cone 2, movably placed upon the connecting rod 6, cannot retract, which results in the preservation of the minimal overlapping 9, as shown in Fig. H. Thereby the locking pawl 1 cannot press the locking cone 2 upwardly and remains engaged with the parking lock gear 4, as shown in Fig. H′.

Every structural design, especially every spatial development and arrangement of the means for preventing the retraction of the locking member from the guide plate, insofar as technically important, even if those designs are not explicitly shown in the Figures or in the description, fall under the protection of the instant claims without the operation of the parking lock mechanism such as indicated in the claims being affected.

### REFERENCE NUMERALS

1 locking pawl
2 locking cone
3 guide plate
4 parking lock gear
5 spring
6 connecting rod
7 tooth of the locking pawl
8 tooth of the parking lock gear
9 minimal overlapping
10 stop

1-4. (canceled)

5. A parking lock mechanism for a motor vehicle having an automatic transmission, particularly a continuously variable belt transmission, the parking lock mechanism comprising a locking pawl tiltably situated on one end and which, when the parking lock is activated, engages with a tooth in a parking lock gear non-rotatably situated upon one of an output shaft and a secondary shaft and a locking member which is movably situated against a force of a spring upon a connecting rod connected with a selector mechanism, and by its movement the locking pawl is rotatable to a locking position between the locking pawl and one of a guide plate and a supporting bolt, on one of an end of the connecting rod (6) remote from the selector mechanism or on the free end of the connecting rod (6), and a means (10) is provided to prevent retraction of the locking member (2) from the guide plate (3) when the parking lock is activated.

6. The parking lock mechanism according to claim 5, wherein a stop (10) is provided on the free end of the connecting rod (6) to prevent the retraction of the locking member (2) from the guide plate (3).

7. The parking lock mechanism according to claim 6, wherein the stop (10) for the connecting rod (6) is a hole into which projects in the free end of the connecting rod (6).

8. The parking lock mechanism according to claim 5, wherein the locking member (2) is a locking cone.

9. A parking lock mechanism for a motor vehicle having an automatic transmission, the parking lock mechanism comprising a locking pawl tiltably situated on one end and which, when the parking lock is activated, engages with a tooth in a parking lock gear non-rotatably situated upon one of an output shaft and a secondary shaft and a locking member which is movably situated against a force of a spring upon a connecting rod connected with a selector mechanism, and by its movement the locking pawl is rotatable to a locking position between the locking pawl and one of a guide plate and a supporting bolt, on one of an end of the connecting rod (6) remote from the selector mechanism or on the free end of the connecting rod (6), and a mechanism (10) is provided to prevent retraction of the locking member (2) from the guide plate (3) when the parking lock is activated.
